(19) United States
(12) Patent Application Publication
(10) Pub. No.: US 2002/0029388 A1
(43) Pub. Date: Mar. 7, 2002

(54) Interactive toy system

(76) Inventor: Bernd Heisele, Schorndorf (DE)

Correspondence Address: Bernd Heisele, MIT, E25-201, 45 Carleton St., Cambridge, MA, 02142, US

(21) Appl. No.: 09/858,169

(22) Filed: May 15, 2001

Related U.S. Application Data
(60) Provisional application No. 60/213,447, filed on Jun. 22, 2000.

(51) Int. Cl. H04N 7/18

(52) U.S. Cl. 725/74

(57) ABSTRACT

The invention describes an interactive toy system for entertainment and educational purposes. The interactive toy system includes an interactive toy, video and audio input devices and a computer. The video and audio devices observe the interaction between the player and the toy to provide the toy with simulated visual/listener abilities. The video and audio signals are transmitted to a computer which processes the signals and generates control signals that are forwarded to the interactive toy. The toy includes devices that operate under the control of the computer to provide the toy with a variety of abilities such as speech, gestures and walking.

### DESCRIPTION

1. Field of Invention

The invention relates to the field of toys for entertainment and education of children.

2. Background

Current toys have a limited capability of interacting with the player. Most of them react only on manual inputs, e.g. a doll that laughs when a child pushes its stomach. Toys with more complex interaction capabilities are desired to provide the player with more enriching playing experiences. These interactive toys require sensors (e.g. video sensors, microphones) to observe the interaction between the player and the toys and a computer which processes the sensory data and controls the responses of the interactive toys. The wide extension of personal computers (PCs) for private use and the improving priceperformance ratio of video cameras with PC connections form the ideal basis to build affordable, interactive toy systems.

### RELATED PATENTS

U.S. Pat. No. 6,064,854 Computer assisted interactive entertainment/educational character goods. Character good that includes video input devices and electromechanical output devices that operate to manifest gesture responses under the control of an external computer. U.S. Pat. No. 6,022,273 Interactive doll. Wireless computer controlled toy system including various types of sensors.

### SUMMARY

The invention describes an interactive toy system for entertainment and educational purposes. The interactive toy system includes one or more toys, where at least one toy has interactive abilities, video and audio input devices external to the toys and an external computer. The video and audio devices observe the interaction between the child and the toys to provide the interactive toys with simulated visual and listener abilities. The video and audio signals are transmitted to a computer which processes the signals and generates control signals that are forwarded to the interactive toy. Each interactive toy includes devices that operate under the control of the computer to provide the toy with simulated, human abilities, such as speech, crying, laughing and gestures.

### BRIEF DESCRIPTION OF DRAWINGS

The present invention will be described by way of exemplary embodiments, but not limitations, illustrated in the accompanying drawings:

FIG. 1 illustrates an overview of the present invention.

FIG. 2 illustrates the hardware structure of an interactive toy.

FIG. 3 is a block diagram illustrating the hardware view of one embodiment of a computer suitable for use to practice the present invention.

### DETAILED DESCRIPTION OF DRAWINGS

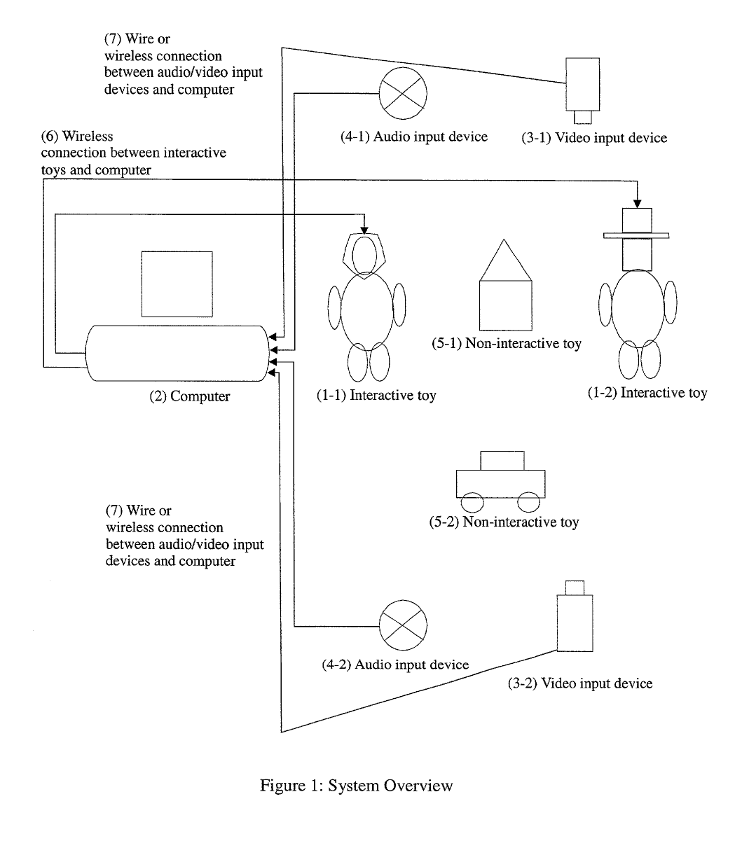

FIG. 1 illustrates an overview of a possible embodiment of the interactive toy system including two interactive toys (1-1) and (1-2), an external computer (2), two video input devices (3-1) and (3-2), two audio input devices (4-1) and (4-2), and two non-interactive toys (5-1) and (5-2). The video and audio input devices observe the interaction between the player and the toys. They are external to the toys and communicatively coupled with the computer (7). The computer processes the video and audio signals and generates control commands that are forwarded to the interactive toys. The interactive toys are communicatively coupled to the computer by a wireless connection (6). The interactive toys manifest various responses under the control of the computer.

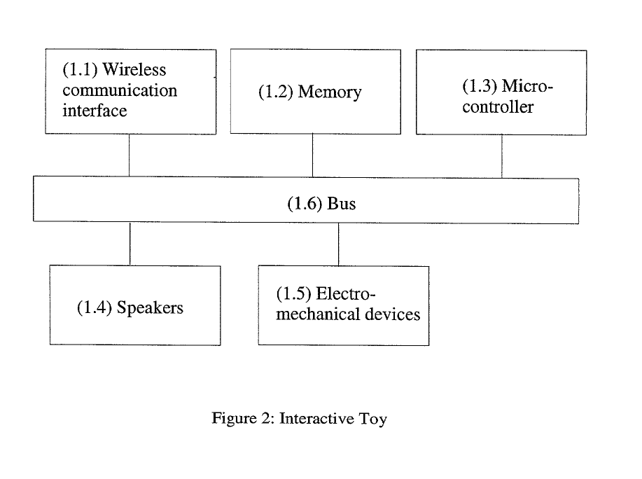

FIG. 2 illustrates an internal hardware architectural view of one embodiment of an interactive toy (1-1), (1-2). The toy includes speakers (1.4) and electromechanical devices (1.5) that operate to manifest various responses under the control of computer (2). The interactive toy also includes a micro-controller (1.3), memory (1.2), communication and other control software stored therein, a wireless communication interface (1.1) and a bus (1.6). The elements are coupled to each other as shown. Micro-controller (1.3) and memory (1.2) operate to receive the control signals from computer (2) through wireless communication interface (1.1), and forward the control signals to speakers (1.4) and electromechanical devices (1.5) through bus (1.6).

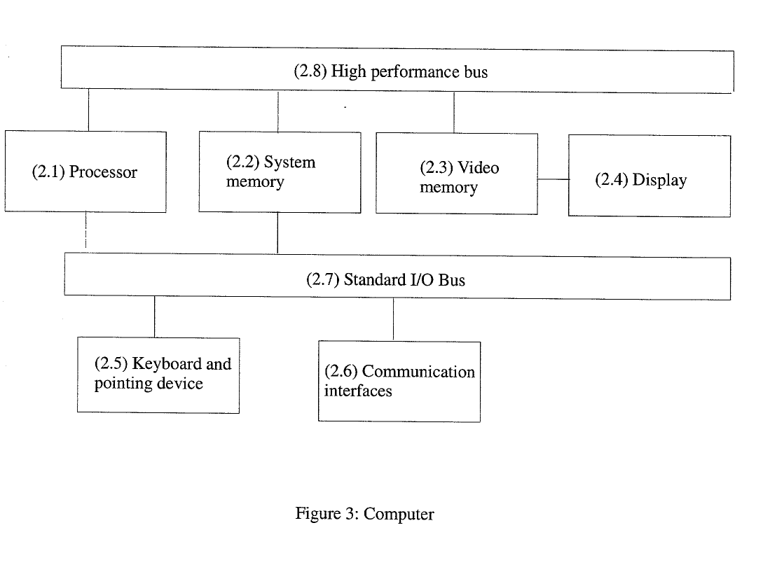

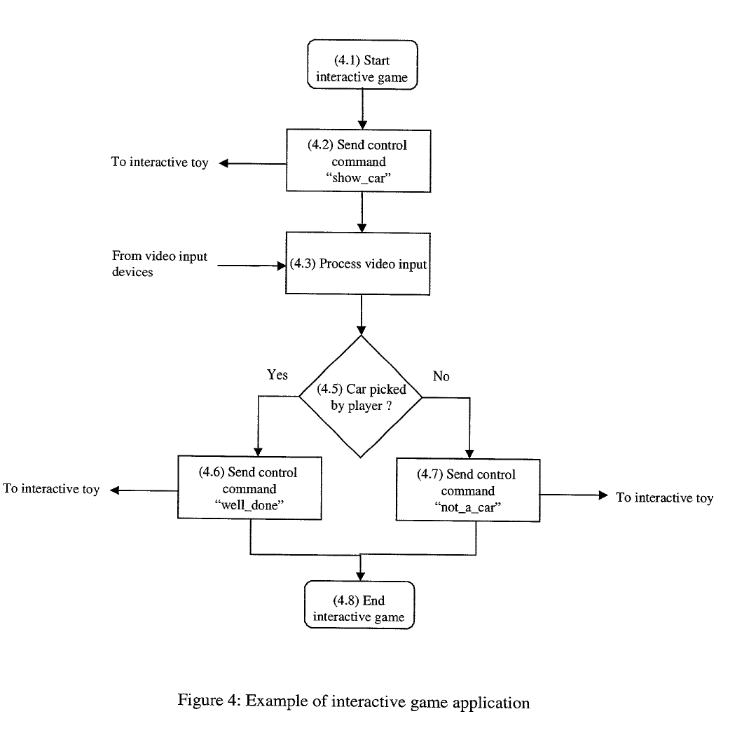

FIG. 3 illustrates a schematic hardware view of one embodiment of a computer (2). As shown, for the illustrated embodiment, the computer includes a processor (2.1), high performance bus (2.8) and a standard I/O bus (2.7). Coupled to high performance bus (2.8) are processor (2.8), system memory (2.2) and video memory (2.3), against which video display (2.4) is coupled. Coupled to standard I/O bus (2.7) are keyboard and pointing device (2.5), processor (2.8), and communication interfaces (2.6). Depending on the embodiment, communication interfaces (2.6) may include wireless interfaces, serial interfaces, and so forth. These elements perform their conventional functions known in the art. In particular, the system memory (2.2) is used to store permanent and working copies for processing video and audio signals. The user can switch between interactive game applications using keyboard or pointing device (2.5). The display (2.4) might be used for displaying visual output as part of an interactive game application.

FIG. 4 illustrates a simple example of an interactive game application. The game starts by sending a control command “show—caf” (4.2) from the computer (2) to the interactive toy (1-1) such that the toy requests the player to pick the toy car (5-2), by letting the interactive toy (1-1), say¹ “please show me the car”. The reaction of the player is observed by the video input devices (3-1) and (3-2). The video signals are forwarded to the computer (2) and processed (4.3) in order to recognize the toy that has been selected by the player. If the player picked the requested toy, toy car (5-2), the computer sends a control signal “well_done” (4.4) prompting the interactive toy (1-1) to say “well done”. If the player picked the wrong toy, e.g. the toy house (5-1), the computer sends a control command “not_a_car” that prompts the interactive toy (1-1) to say “that is not the car”. Here and in the remainder of this paragraph “say” in context with the interactive toy (1-1) means that the interactive toy (1-1) generates synthetic speech via the speakers (1.4) integrated into (1-1).

1. A toy system including
a) One or more interactive toys. Each interactive toy includes an audio output device providing the toy with simulated speech ability. The audio device is communicatively coupled to an external computer. The audio device operates under the control of the external computer.
b) One or more video input devices and/or one or more audio input devices external to the toys, observing the interaction between the player and the toys and providing the interactive toys with simulated vision and/or listener abilities. The video and audio devices are communicatively coupled to a computer and transmit their signals to the computer.
c) A computer which processes the incoming video and audio signals and generates control signals which are forwarded to the interactive toys.

2. A toy system according to claim 1 where the interactive toy described in 1a) includes one or more electromechanical devices that are communicatively coupled to the external computer. The electromechanical devices are controlled by the external computer and provide the toys with mechanical responses (e.g. opening of the eyes, opening of the mouth, gestures, walking).

3. A toy system according to claim 1 wherein the interactive toy described in 1a) further includes a communication interface connected to the audio output devices as well as to the electromechanical output devices. The communication interface is communicatively coupled to the external computer and exercises control over the audio and electromechanical output devices by the external computer.

4. The toy system according to claim 3, wherein the communication interface is a serial interface.

5. The toy system according to claim 3, wherein the communication interface is a wireless interface

6. The toy system according to claim 1, wherein the interactive toy described in 1a) further includes a micro-controller that facilitates the control of the audio output devices by the external computer.

7. The toy system according to claim 6, wherein the micro-controller also facilitates the control of the electromechanical output devices by the external computer.

8. The toy system according to claim 6, further including a communication interface connected to the micro-controller and communicatively coupled to the external computer that facilitates the exercise of control over the audio output devices.

9. The toy system according to claim 8, wherein the communication interface also facilitates the exercise of control over the electromechanical output devices.

10. A toy system according to claim 1 further comprising one or more toys that are not coupled to the computer.

11. A method comprising
a) Generating video and/or audio signals responsive to the scenery in the surrounding of the toys through video and/or audio input devices external to the toys.
b) Forwarding the video and/or audio signals to a computer external to the toys.
c) Processing of the video and/or audio signals on the external computer.
d) Generating control commands on the computer and forwarding the control commands to the interactive toys.

12. A method according to claim 11 wherein processing the video signals according to claim 11 c) comprises a method where the video signals of multiple video input devices are used to recover depth information about the scenery observed by the video input devices.

13. A method according to claim 11 wherein processing the video signals according to claim 11 c) comprises a method which estimates the position and/or orientation of a toy in the scenery using information about the surface properties (color, texture) and/or shape of the toy.

14. A method according to claim 11 wherein processing the video signals according to claim 11 c) comprises a method that estimates the position and orientation of the toys relative to each other using information about the surface properties and/or shape of the toys.

15. A method according to claim 11 wherein processing the video signals according to claim 11 c) comprises a method for calibrating the video input devices using one or more toys as calibration objects.

16. A method according to claim 11 wherein processing the video signals according to claim 11 c) comprises a method for detecting moving objects in order to track the motion of the player and/or the toys.

17. A method according to claim 11 wherein processing the video signals according to claim 11 c) comprises a method for recognition of text in order to provide the interactive toys with simulated reading ability.

18. A method according to claim 11 wherein processing the audio signals according to claim 11 c) comprises a method for recognition of sound signals to provide the interactive toys with simulated listener ability.

19. A method according to claim 11 wherein processing the audio signals according to claim 11 c) comprises a method for recognition of speech to provide the interactive toys with simulated listener ability.

20. A method according to claim 11 wherein the flow of control signals depends on an interactive game application.

21. A method according to claim 20 further including a method allowing a person to select an interactive game application from a set of interactive game applications. The person uses an input device connected to the computer to make the selection.

22. A method according to claim 11 further including a method that generates visual output on a display connected to the computer as part of an interactive game application.
